(19) United States
(12) Patent Application Publication
(10) Pub. No.: US 2014/0218895 A1
(43) Pub. Date: Aug. 7, 2014

(54) KNIFE WITH ILLUMINATION AND FLOATING MEANS

(71) Applicant: Jose E. Pino, Miami, FL (US)

(72) Inventor: Jose E. Pino, Miami, FL (US)

(21) Appl. No.: 13/762,336

(22) Filed: Feb. 7, 2013

(51) Int. Cl. B26B 11/00; F21V 33/00; F21V 31/00

(52) U.S. Cl. CPC B26B 11/008; F21V 31/00; F21V 33/0084
USPC 362/120

(57) ABSTRACT

A knife with illumination and floating means is presented. In an embodiment, a knife is presented having a handle and blade. The handle has a waterproof battery compartment that acts as a floatation means. Also the handle has a waterproof battery compartment cover (60) and a waterproof on/off switch to turn a light that shines on the blade on or off. Also, a sheath is removably disposed to the blade via a locking arm. The sheath has a belt clip also.

### RELATED APPLICATIONS

This non-provisional patent application claims priority from provisional patent application No. 61/633,223, filed on 7 Feb. 2012, titled FILET KNIFE HAVING L.E.D. LIGHTS AT FRONT OF HANDLE TO PROVIDE LIGHT WHEN CUTTING BIAT, MEAT.

### FIELD OF INVENTION

This invention relates to knives and means for illuminating an area that is being cut by a knife.

### BACKGROUND OF THE INVENTION

Many times there is a need to use a knife in a dark setting. For example if a fisherman or hunter catches the animal or game before dawn, or after dusk, there may be a need to cut the game. If lighting is poor, then the hunter or fisherman may not exercise the best cuts, and the chance of self-inflicted injury is increased due to the poor visibility.

Also, there are times when the knife being used by the hunter or fisherman falls into a body of water, such as a lake, river, or ocean. Thus there is a need to have a knife that floats so as to not lose the knife having it sink and get lost.

There is also need for a lighted knife that floats, and has a waterproof seal to prevent water or moisture from entering the electrical system, such as the switch, battery, wiring, and light.

There is also a need to have a knife that can be removably disposed in a locking sheath, so the knife does not slip out during travel or otherwise.

While the above prior art devices may be related to the present invention, they have limitations in not providing for lighting on both sides of the blade, not being water-proof, not having the ability to float.

### SUMMARY OF INVENTION

One aspect of the present invention is a knife with illuminating means and floating means, comprising: a handle (20) having a proximal end (140), a distal end (150), said distal end (150) terminating at a face (160); a blade (30) extending from said face (160) secured to said handle (20); said handle (20) having a waterproof on/off switch (50) operably connected to a power source (70) removably disposed within the handle (20); said handle (20) having a waterproof battery compartment cover (60) that is threadably engaged with a proximal end (140) of said handle (20); said handle (20) having a battery compartment (200) therein and accessible when the waterproof battery compartment cover (60) is removed so that battery (70) can be securely and operably disposed within said battery compartment (200) when the waterproof battery compartment cover (60) is tightly threaded with the handle (20); said battery compartment (200) also is a floating means (210) because the knife handle (20) and blade (30) displace more water than its weight due to the air in the floating means (210); and said face (160) having a light (40) disposed thereon and positioned to illuminate a cutting surface (170).

These and other features, aspects and advantages of the present invention will become better understood with reference to the following drawings, description and claims.

### BRIEF DESCRIPTION OF THE DRAWINGS

For a fuller understanding of the invention, reference should be made to the following detailed description, taken in connection with the accompanying drawings, in which:

FIG. 1 is a perspective view of one embodiment of the present invention.

FIG. 2 is another perspective view of one embodiment of the present invention.

FIG. 3 is another perspective view of an embodiment of the present invention.

FIG. 4 is a sectional view of an embodiment of the present invention.

FIG. 5 is another embodiment of the present invention.

### REFERENCE NUMERALS

10 knife with illumination and floating means
20 handle
30 blade
40 light
50 waterproof on/off switch
60 waterproof battery compartment cover
70 power source
80 electrical conduit
90 ridge
100 sheath
110 belt clip
120 locking arm
130 indent
140 proximal end
150 distal end
160 face
170 cutting edge
180 finger grip
190 cavity
200 battery compartment
210 floating means

### DETAILED DESCRIPTION OF THE PREFERRED EMBODIMENT

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

In the following detailed description of the preferred embodiments, reference is made to the accompanying drawings, which form a part hereof, and within which are shown by way of illustration specific embodiments by which the invention may be practiced. It is to be understood that other embodiments by which the invention may be practiced. It is to be understood that other embodiments may be utilized and structural changes may be made without departing from the scope of the invention.

The term “about” or “approximately” as used herein refers to being within an acceptable error range for the particular value as determined by one of ordinary skill in the art, which will depend in part on how the value is measured or determined, i.e. the limitations of the measurement system, i.e. the degree of precision required for a particular purpose.

The terms “person” and “user” are used interchangeably herein to refer to a human who is using the present invention and/or using an embodiment of the device disclosed herein.

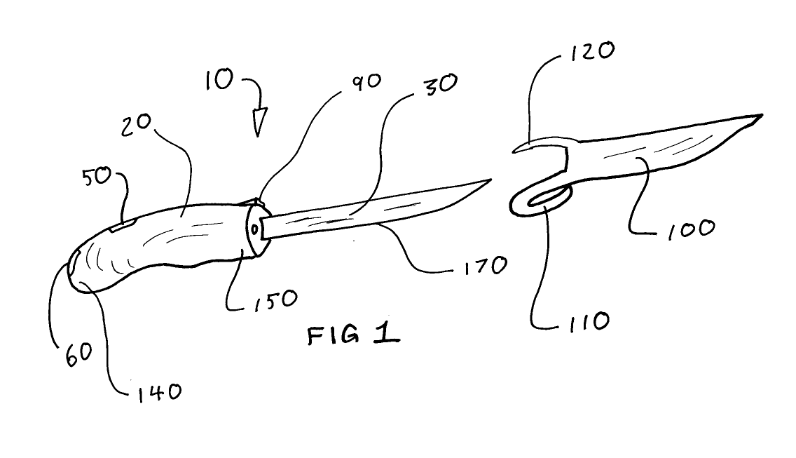

In one embodiment represented by FIG. 1, the present invention 10, also referred to herein as a knife with illumination and floating means 10 has a handle 20 connected to a blade 30. The handle 20 may have a proximal end 140, and an opposed distal end 150. The distal end may terminate at a face 160. The face may have a light 40 disposed thereon to illuminate the cutting surface 170 of the blade so that someone using the knife 10 can see what they are cutting if there is otherwise no light or poor lighting conditions. This way, the invention can be used as a flashlight. In one embodiment, there may be two lights 40 on the face, one light 40 may illuminate one side of the blade 30, and the other light 30 may illuminate the other side of the blade 30.

FIG. 1 also illustrates a handle 20 having a waterproof on/off switch 50 that is operably connected to the light 40 and a power source 70 to turn the light 40 on and off. This way the user does not need to constantly hold or depress a button to keep the light illuminated. FIG. 1 also illustrates a waterproof battery compartment cover 60 disposed near the proximal end 140. The top of the handle 20 may also have a ridge disposed at the distal end 150 to lockingly engage with a locking arm 120 of a sheath 100. Specifically the locking arm 120 may have an indent 130 which may receive a portion of the ridge 90 to secure the knife 10 within the sheath 100 so that the blade 30 does not fall out of the sheath 100. The locking arm 120 can bend slightly away from the ridge 10 when the handle 20 is pulled away from the sheath 100.

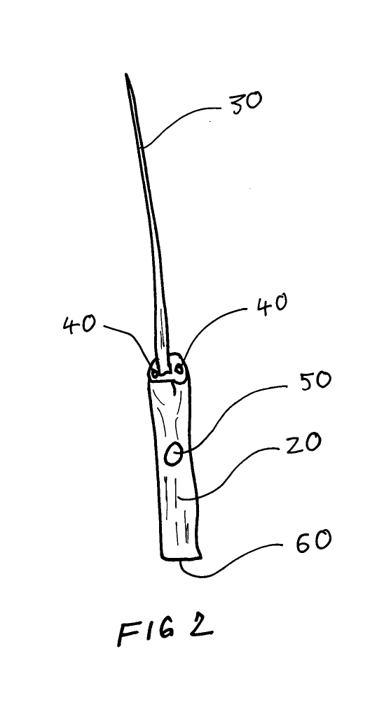

FIG. 2 illustrates another embodiment of the present invention. This “top” view illustrates the waterproof on/off switch 50, a light 40 on the face 160 so as to provide illumination to each side of the blade 30.

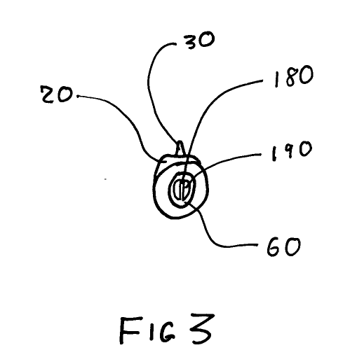

FIG. 3 illustrates one embodiment of the present invention 10, providing mainly a rear view, showing an embodiment of the waterproof battery compartment cover 60 having a finger grip 180 that can be grabbed by the fingers of the user and can be threadably engaged with the proximal end 140. The finger grip 180 may have a cavity 190 on either side so that the fingers of the user can be disposed in the cavity 190 so the user can grip the finger grip 180, to unscrew the waterproof battery compartment cover 60.

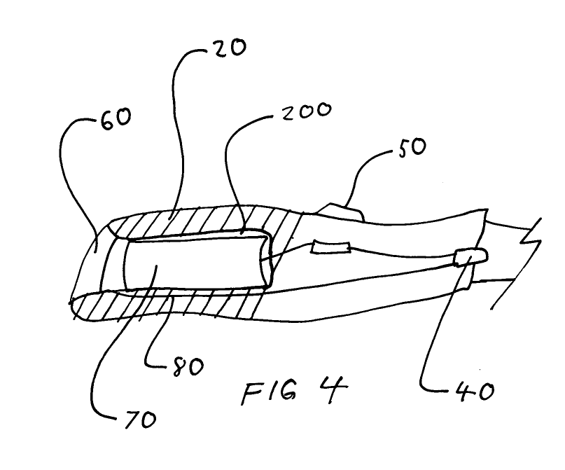

FIG. 4 illustrates a sectional view of the handle 20 showing a power source 70, specifically a battery 70 that is removably secured within the handle 20. The power source 70 is operably connected to the waterproof on/off switch 50 and the light 40 so that a user can turn the light 40 on and off by controlling the waterproof on/off switch. The light 40 may be a light emitting diode (LED) 40.

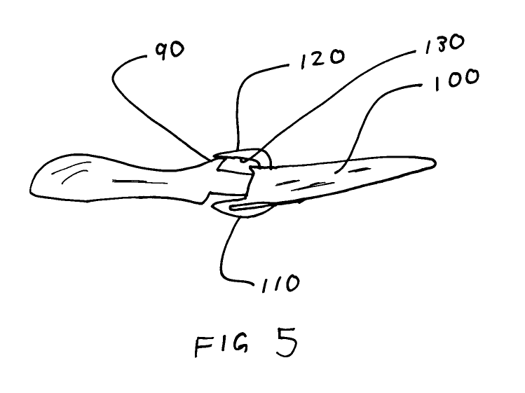

FIG. 5 illustrates an embodiment of the present invention 10, showing the blade 30 being partially removed from the sheath 100. The ridge 90 is illustrated removed from the indent 130 and shown touching the locking arm 120. A belt clip 110 may be disposed on the sheath 100 so that sheath 100 can be removably secured to a belt or similar structure.

The disclosures of all publications, if any cited herein are expressly incorporated herein by reference, each in its entirety, to the same extent as if each were incorporated by reference individually.

It is also to be understood that the following claims are intended to cover all of the generic and specific features of the invention herein described, and all statements of the scope of the invention which, as a matter of language, might be said to fall there between.

It should be understood, of course, that the foregoing relates to exemplary embodiments of the invention and that modifications may be made without departing from the spirit and scope of the invention as set forth in the following claims.

I claim:

1. A knife with illuminating means and floating means, comprising:
A handle (20) having a proximal end (140), a distal end (150), said distal end (150) terminating at a face (160);
a blade (30) extending from said face (160) secured to said handle (20);
said handle (20) having a waterproof on/off switch (50) operably connected to a power source (70) removably disposed within the handle (20);
said handle (20) having a waterproof battery compartment cover (60) that is threadably engaged with a proximal end (140) of said handle (20);
said handle (20) having a battery compartment (200) therein and accessible when the waterproof battery compartment cover (60) is removed so that battery (70) can be securely and operably disposed within said battery compartment (200) when the waterproof battery compartment cover (60) is tightly threaded with the handle (20);
said battery compartment (200) also is a floating means (210) because the knife handle (20) and blade (30) displace more water than its weight due to the air in the floating means (210); and
said face (160) having a light (40) disposed thereon and positioned to illuminate a cutting surface (170).

2. The apparatus of claim 2, further comprising:
a sheath (100) having a belt clip (110) secured thereto so that a user can removably secure said sheath (100) to said blade (30), said sheath having a locking arm (120) that extends from a top of said sheath (100) rearwardly;
said locking arm (120) having an indent (130) that removably engages with a ridge (90) on a top side of said handle (20).
device for stimulating eye movement in a subject comprising:
